(19) United States
(12) Patent Application Publication
(10) Pub. No.: US 2007/0197119 A1
(43) Pub. Date: Aug. 23, 2007

(54) Method for forming pattern, droplet ejection apparatus, electro-optic device, method for forming alignment film, apparatus for forming alignment film, and liquid crystal display

(75) Inventor: Yuji Iwata, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/709,176

(22) Filed: Feb. 21, 2007

(30) Foreign Application Priority Data
Feb. 22, 2006 (JP) 2006-044858
Jan. 10, 2007 (JP) 2007-002546

(51) Int. Cl. H01J 9/24; H01J 9/00

(52) U.S. Cl. 445/24

(57) ABSTRACT

A method for forming a pattern on a substrate by ejecting droplets containing a pattern forming material from an ejection head onto the substrate is disclosed. The ejection head has ejection ports that are aligned along a surface of the substrate. While the substrate is being moved relative to the ejection head, droplets containing the pattern forming material are ejected from the ejection ports along a direction of ejection that is inclined with respect to a normal line of the substrate. The ejection of the droplet is performed in a state where the alignment direction of the ejection ports is inclined with respect to the movement direction of the substrate.

### CROSS-REFERENCE TO RELATED APPLICATIONS

This application is based upon and claims the benefit of priority from prior Japanese Patent Application Nos. 2006-044858 filed on Feb. 22, 2006, and 2007-002546 filed on Jan. 10, 2007, the entire contents of which are incorporated herein by reference.

### BACKGROUND

The present invention relates to a method for forming a pattern, a droplet ejection apparatus, an electro-optic device, a method for forming an alignment film, an apparatus for forming an alignment film, and a liquid crystal display.

A procedure for manufacturing a display or a semiconductor device includes a number of steps of forming a patterned film. Specifically, the patterned film is formed by depositing a film on a substrate and subjecting the film to patterning in a predetermined shape.

To improve productivity, this type of process for forming a pattern such as a film now employs an inkjet method. In the method, a film is formed by ejecting droplets of liquid onto a substrate and solidifying the droplets on the substrate. The film is thus formed on the substrate in correspondence with the shapes of the droplets. This makes it unnecessary to form a mask for patterning, thus decreasing the number of the steps for forming the film.

However, in formation of the film by the inkjet method, some of the ejected droplets may not spread wet and form recesses and projections on the surface of the substrate. The film reflects the recesses and projections, thus causing unevenness in the film or non-uniform thicknesses of the film.

To solve this problem, a method for promoting wet spreading of the droplets on the surface of the substrate has been proposed. As described in JP-A-2005-131498, droplets of liquid are ejected in a direction inclined with respect to a normal line of a substrate. This provides an element of velocity in a direction along the surface of the substrate to each of the ejected droplets. The droplets thus effectively spread wet along the surface of the substrate at an angle (an inclination angle) defined by the normal direction of the substrate and the ejecting direction of the droplets.

To change the thicknesses of the film by the aforementioned inkjet method, the ejection amount of droplets per unit area is altered. In this case, as illustrated in FIG. 11, while maintaining the volume of each droplet Fb at a constant level, the ejection interval of the droplets Fb, or the ejection pitch W, is selectively increased and decreased. For example, to form a film FP with a smaller thickness, the ejection pitch W of the droplets Fb is increased while maintaining the volumes of the droplets Fb at a constant level. Specifically, the relative velocity between a droplet ejection nozzle and the substrate Sb is increased or the time corresponding to a cycle of ejection is extended. This stabilizes ejection of droplets of liquid, ensuring sufficient reproducibility of the ejection amount, or the thickness of the film.

However, if the ejecting direction A of the droplets Fb is inclined with respect to the normal direction (direction Z) of the substrate Sb, each of the ejected droplets Fb forms a substantially oval shape having a major axis extending in a direction (direction X) perpendicular to the normal direction of the substrate Sb and a minor axis extending in the alignment direction (direction Y) of nozzles N. This causes the following problem.

Since the thickness of each droplet Fb, which has the oval shape, is relatively small, the flowability of the droplet Fb is decreased. This reduces the thickness of a joint portion between each adjacent pair of the droplets Fb in the direction (direction Y) defined by the minor axis of the droplet Fb. An empty portion (a recess B) in which the droplet Fb is not provided is thus formed in each of the areas on the substrate Sb facing the spaces between each adjacent pair of the nozzles N. As a result, the thickness of the area of the film FP corresponding to each recess B becomes extremely small, thus causing significant unevenness of the thickness of the film FP.

### SUMMARY

Accordingly, it is an objective of the present invention to provide a method for forming a pattern, a droplet ejection apparatus, and an electro-optic device that increase uniformity of the thickness of a pattern formed by droplets.

To achieve the foregoing objective, in accordance with a first aspect of the present invention, a method for forming a pattern on a substrate by ejecting droplets containing a pattern forming material from an ejection head onto the substrate is provided. The method forming method includes: moving at least one of the ejection head and the substrate relative to the other, wherein the ejection head has a plurality of ejection ports that are aligned along a surface of the substrate; inclining the direction of alignment of the ejection ports with respect to the direction of the relative movement; and ejecting droplets containing the pattern forming material from the ejection ports along a direction of ejection that is inclined with respect to a normal line of a substrate while executing the relative movement.

In accordance with a second aspect of the present invention, a droplet ejection apparatus is provided that ejects droplets containing a pattern forming material onto a substrate, thereby forming a pattern on the substrate. The droplet ejection apparatus includes an ejection head, a movement mechanism, a tilt mechanism, and a pivot mechanism. The ejection head has a plurality of ejection ports that are aligned along one direction. The droplets are ejected from the ejection ports onto the substrate. The movement mechanism moves at least one of the ejection head and the substrate relative to the other. The tilt mechanism tilts the ejection head about a tilt axis that is parallel with the alignment direction of the ejection ports, in such a manner that a direction of ejection of the droplets from the ejection ports is inclined with respect to a normal line of the substrate. The pivot mechanism pivots the ejection head about a pivotal axis that is parallel with a normal line of the substrate, in such a manner that the alignment direction of the ejection ports is inclined with respect to the direction of the relative movement.

In accordance with a third aspect of the present invention, an electro-optic device is provided that has a substrate on which a pattern has been formed by the droplet ejection apparatus in accordance with the second aspect of the present invention.

In accordance with a fourth aspect of the present invention, a method for forming an alignment film on a substrate by ejecting droplets containing an alignment film forming material from an ejection head onto the substrate is provided. The alignment film forming method includes: moving at least one of the ejection head and the substrate relative to the other, wherein the ejection head has a plurality of ejection ports that are aligned along a surface of the substrate; inclining the direction of alignment of the ejection ports with respect to the direction of the relative movement; and ejecting droplets containing the alignment film forming material from the ejection ports along a direction of ejection that is inclined with respect to a normal line of a substrate while executing the relative movement.

In accordance with a fifth aspect of the present invention, an alignment film forming apparatus is provided that forms an alignment film on a substrate by ejecting droplets containing an alignment film forming material onto the substrate. The alignment film forming apparatus includes an ejection head, a movement mechanism, a tilt mechanism, and a pivot mechanism. The ejection head has a plurality of ejection ports that are aligned along one direction. The droplets are ejected from the ejection ports onto the substrate. The movement mechanism moves at least one of the ejection head and the substrate relative to the other. The tilt mechanism tilts the ejection head about a tilt axis that is parallel with the alignment direction of the ejection ports, in such a manner that a direction of ejection of the droplets from the ejection ports is inclined with respect to a normal line of the substrate. The pivot mechanism pivots the ejection head about a pivotal axis that is parallel with a normal line of the substrate, in such a manner that the alignment direction of the ejection ports is inclined with respect to the direction of the relative movement.

In accordance with a sixth aspect of the present invention, a liquid crystal display is provided that has a substrate on which an alignment film has been formed by the alignment film forming apparatus in accordance with the fifth aspect of the present invention.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view showing a liquid crystal display;

FIG. 2 is a cross-sectional view taken along line 2-2 of FIG. 1;

FIG. 3 is a perspective view showing the droplet ejection apparatus;

FIG. 4 is a perspective view showing a droplet ejection head of the droplet ejection apparatus of FIG. 3;

FIG. 5 is a plan view showing the droplet ejection head of FIG. 4;

FIG. 6 is a side view showing the droplet ejection head of FIG. 4;

FIG. 7 is a partially cross-sectional view showing the droplet ejection head of FIG. 4;

FIG. 8 is a view illustrating operation of the droplet ejection head of FIG. 4;

FIG. 9 is a view illustrating droplet ejection by the droplet ejection apparatus of FIG. 3;

FIG. 10 is a block diagram representing the electric configuration of the droplet ejection apparatus of FIG. 3; and

FIG. 11 is a side view schematically showing a conventional droplet ejection apparatus.

### DESCRIPTION OF EXEMPLARY EMBODIMENTS

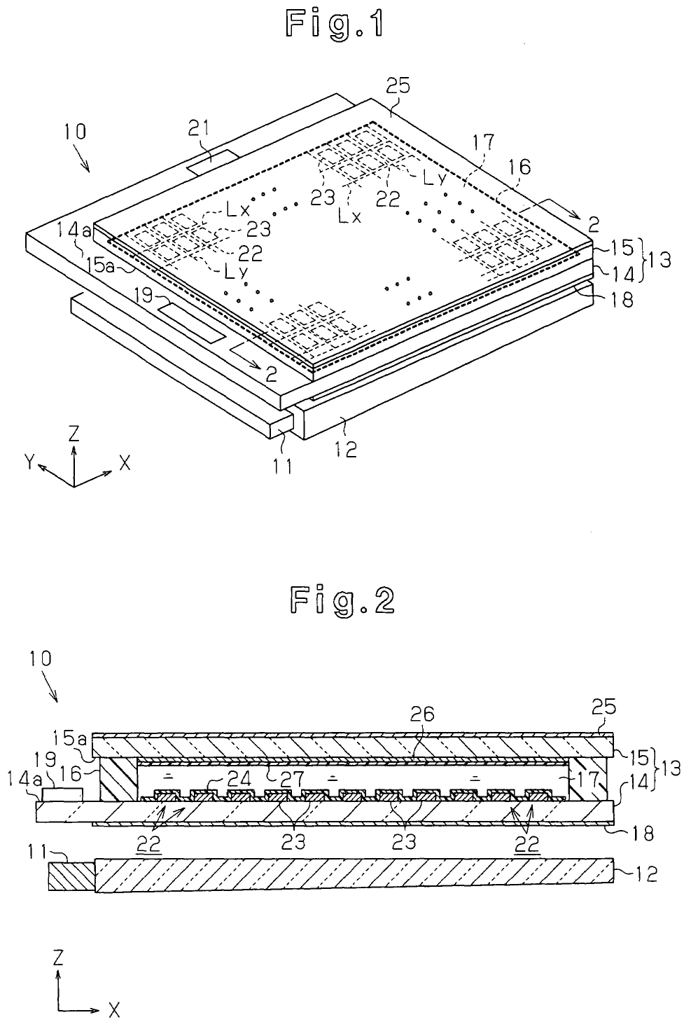

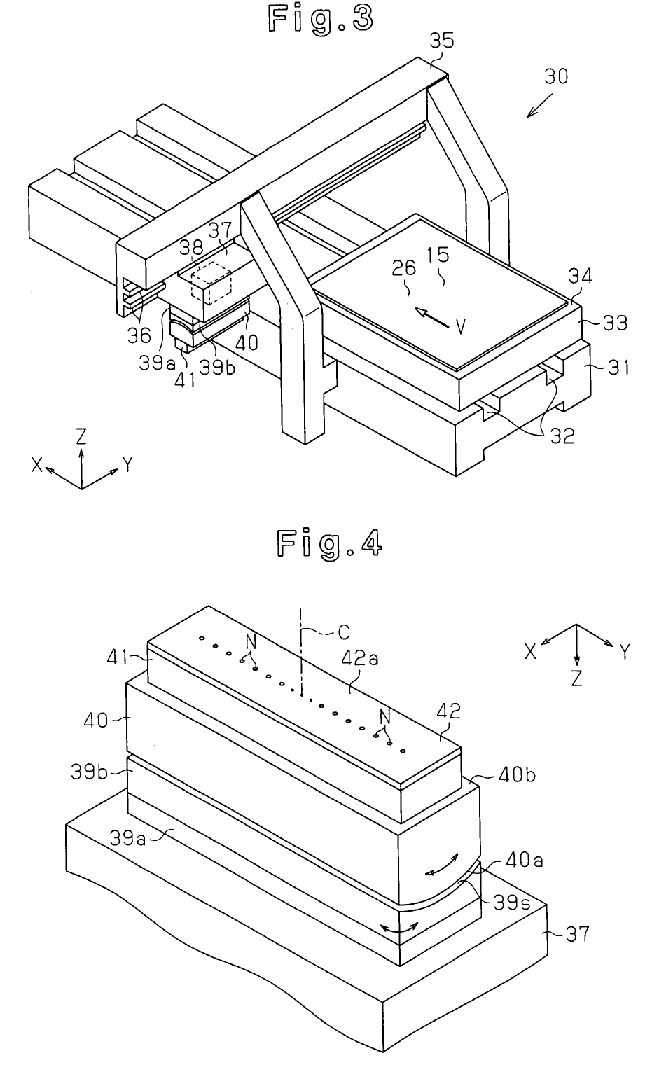

An embodiment of the present invention will now be described with reference to FIGS. 1 to 10. First, a liquid crystal display 10, or an electro-optic device, will be explained. The liquid crystal display 10 has an alignment film 27 formed by a method for forming a pattern according to the present invention. FIG. 1 is a perspective view showing the liquid crystal display 10 and FIG. 2 is a cross-sectional view taken along line 2-2 of FIG. 1.

As shown in FIG. 1, the liquid crystal display 10 has an edge light type backlight 12, which is shaped like a rectangular plate and has a light source 11 such as an LED. The backlight 12 is arranged in a lower portion of the liquid crystal display 10. A liquid crystal panel 13, which is shaped like a rectangular plate and sized substantially equal to the size of the backlight 12, is provided above the backlight 12. The light emitted by the light source 11 is radiated onto the liquid crystal panel 13.

The liquid crystal panel 13 has an element substrate 14 and an opposed substrate 15 opposed to the element substrate 14. Referring to FIG. 2, the element substrate 14 and the opposed substrate 15 are bonded together through a seal material 16 having a rectangular frame-like shape and formed of light curing resin. Liquid crystal 17 is sealed in the space between the element substrate 14 and the opposed substrate 15.

An optical substrate 18, such as a polarizing plate or a phase difference plate, is bonded with the lower surface, or the surface facing the backlight 12, of the element substrate 14. The optical substrate 18 linearly polarizes the light of the backlight 12 and emits the light onto the liquid crystal 17. A plurality of scanning lines Lx, which extend in one direction, or direction X, are aligned on the upper surface (an element formation surface 14a), or the surface facing the opposed substrate 15, of the element substrate 14. Each of the scanning lines Lx is electrically connected to a scanning line driver circuit 19 provided on the element substrate 14. A scanning signal generated by the scanning line driver circuit 19 is input to the scanning lines Lx at a predetermined timing. A plurality of data lines Ly extending in direction Y are also aligned on the element formation surface 14a. Each of the data lines Ly is electrically connected to a data line driver circuit 21 formed on the element substrate 14. The data line driver circuit 21 inputs a data signal generated in accordance with display data to the data lines Ly at a predetermined timing.

A pixel 22 is formed in each of the portions defined on the element formation surface 14a by the scanning lines Lx and the data lines Ly, which intersect the scanning lines Lx. In other words, a plurality of pixels 22 are arranged on the element formation surface 14a in a matrix-like manner. A non-illustrated control element such as a TFT or a light transmissible pixel electrode 23 formed by a transparent conductive film is provided in each of the pixels 22.

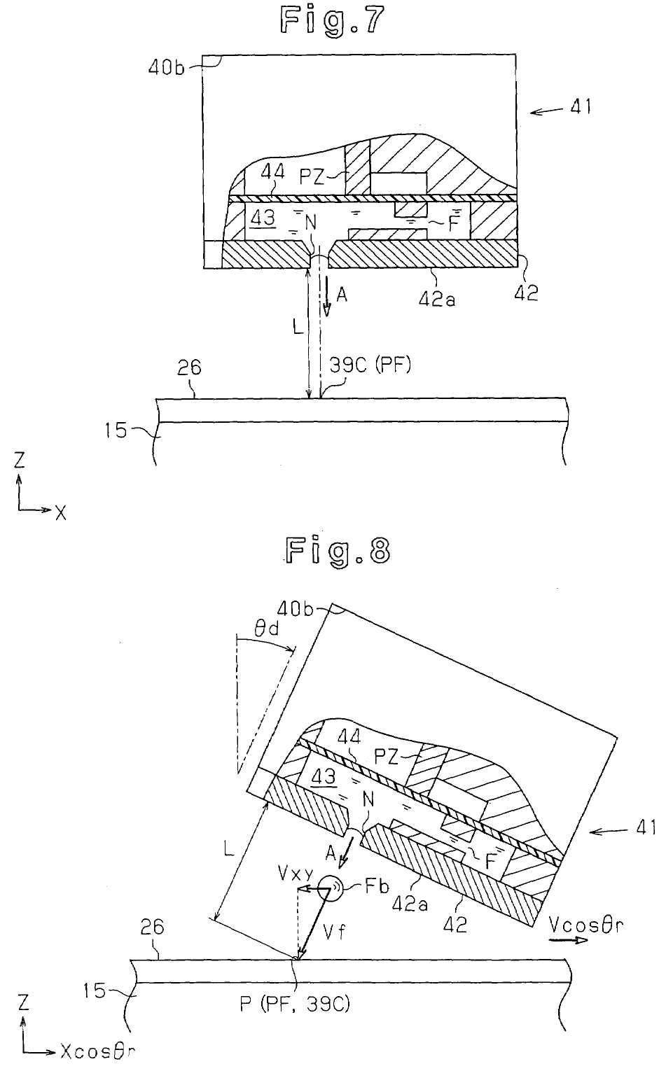

As shown in FIG. 2, an alignment film 24 is deposited on the pixels 22. The alignment film 24 has been subjected to an orientation process through, for example, rubbing. The alignment film 24 is formed of alignment polymers such as alignment polyimide and sets the liquid crystals 17 in a prescribed alignment state in the vicinity of the pixel electrodes 23. The alignment film 24 is formed by the inkjet method. Specifically, a pattern forming material prepared by dissolving the alignment polymers in a prescribed solvent, which is alignment film forming material F (see FIG. 7), is ejected onto each of the pixels 22 as a droplet Fb (FIG. 8). The droplets Fb are then dried to form the alignment film 24.

A polarizing plate 25 is provided on the opposed substrate 15 and sends linear-polarized light proceeding perpendicularly to the light that has transmitted through the optical substrate 18 in an outward direction, or an upward direction as viewed in FIG. 2. An opposed electrode 26 is arranged on the entire portion of the lower surface (an electrode formation surface 15a), or the surface facing the element substrate 14, of the opposed substrate 15. The opposed electrode 26 is formed by a light transmissible conductive film and opposed to the pixel electrode 23. The opposed electrode 26 is electrically connected to the data line driver circuit 21 and receives a predetermined level of common potential from the data line driver circuit 21. An alignment film 27 is arranged on the entire portion of the lower surface of the opposed electrode 26. The alignment film 27 has been subjected to orientation procedure through, for example, rubbing. Like the alignment film 24, the alignment film 27 is formed using the inkjet method. The alignment film 27 sets the liquid crystal 17 in a prescribed alignment state in the vicinity of the opposed electrode 26.

In accordance with line progressive scanning, the scanning lines Lx are selected one by one at predetermined time intervals. The control element of the corresponding one of the pixels 22 is thus turned on for the period in which the scanning line Lx is selected. Respondingly, a data signal, which is generated in accordance with the display data, is input to the pixel electrode 23 corresponding to the control element through the corresponding one of the data lines Ly. This changes the difference between the potential of the pixel electrode 23 and the potential of the opposed electrode 26 in correspondence with the data signal. The alignment state of the liquid crystal 17 between the pixel electrode 23 and the opposed electrode 26 is thus altered. In other words, the polarized state of the light exiting the optical substrate 18 varies for the respective pixels 22 in correspondence with the data signals. Therefore, transmission of the light through the polarizing plate 25 is selectively permitted and prohibited for the respective pixels 22. This displays an image on the upper side of the liquid crystal panel 13 in accordance with the display data.

A droplet ejection apparatus 30, by which the alignment film 27 (the alignment film 24) is formed, will hereafter be explained with reference to FIGS. 3 to 10.

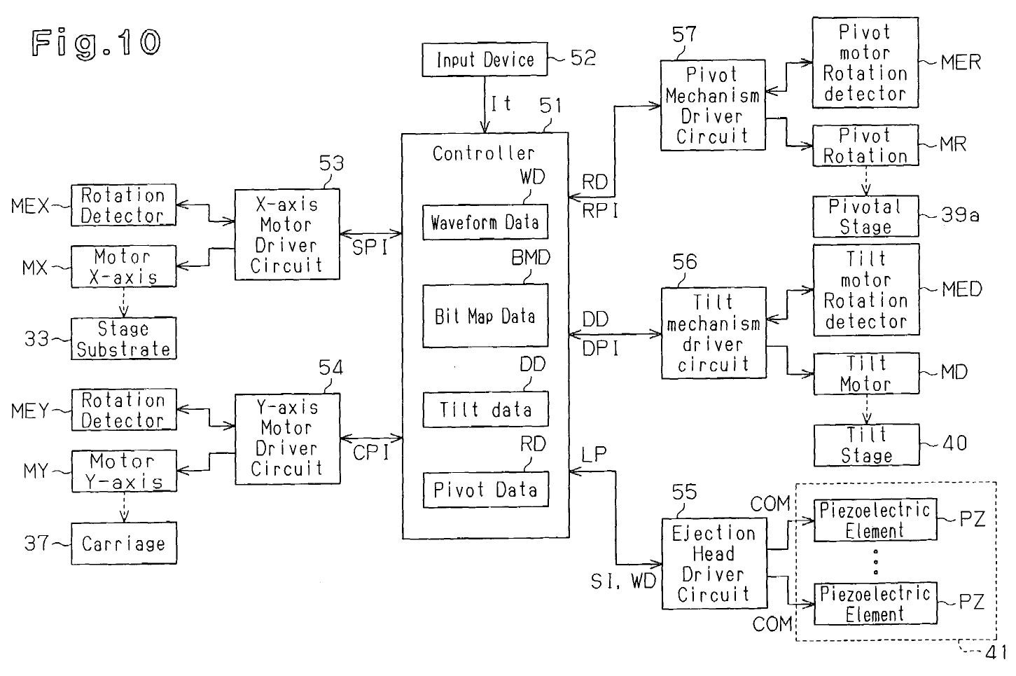

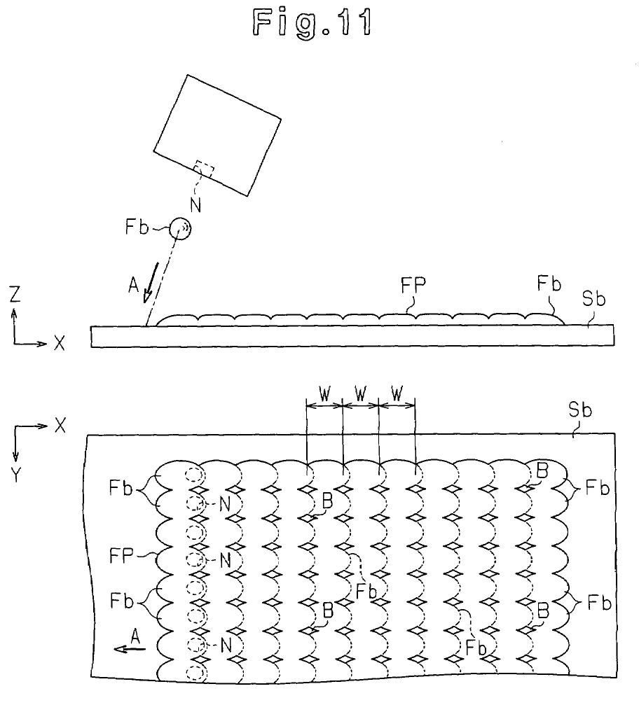

As shown in FIG. 3, the droplet ejection apparatus 30, which is an apparatus for forming an alignment film in the illustrated embodiment, has a rectangular parallelepiped base 31. A pair of guide grooves 32 are defined in the upper surface of the base 31 and extend in the longitudinal direction of the base 31, or direction X. A substrate stage 33, which functions as a movement mechanism, is provided on the base 31 and operationally connected to the output shaft of an X-axis motor MX (see FIG. 10), which is arranged in the base 31. The substrate stage 33 moves along the guide grooves 32, or in direction X, at a predetermined velocity (transport velocity V).

The upper surface of the substrate stage 33 functions as a mounting surface 34 on which the opposed substrate 15 can be mounted. The mounting surface 34 positions and fixes the opposed substrate 15 with respect to the substrate stage 33. The opposed substrate 15 is mounted on the mounting surface 34 with the opposed electrode 26 facing upward. Although the opposed substrate 15 is mounted on the mounting surface 34 in the illustrated embodiment, the element substrate 14 may be mounted on the mounting surface 34 with the pixel electrodes 23 facing upward.

A gate-shaped guide member 35 straddles the base 31 and extends in direction Y. A pair of upper and lower guide rails 36 are formed in the guide member 35, extending in direction Y.

A carriage 37 is provided in the guide member 35 and operationally connected to the output shaft of a Y-axis motor MY (see FIG. 10), which is also arranged in the guide member 35. The carriage 37 moves in direction Y along the guide rails 36. An ink tank 38 is mounted in the carriage 37 and retains the alignment film forming material F (see FIG. 7). The alignment film forming material F can be sent from the ink tank 38 to a droplet ejection head 41, which is arranged on the lower surface of the carriage 37.

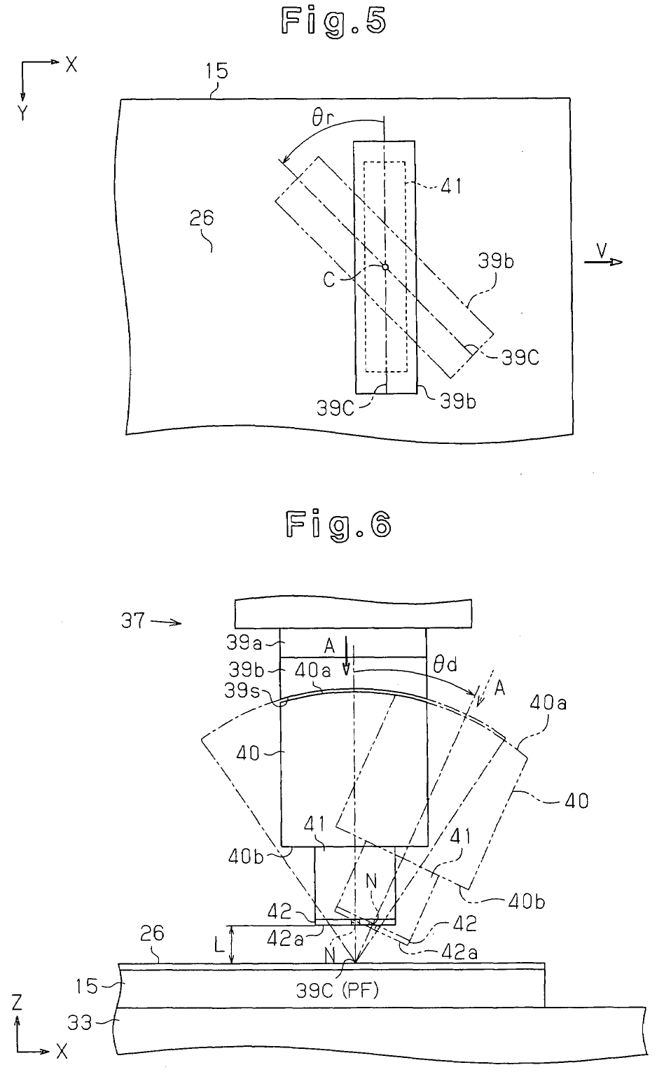

FIG. 4 is a perspective view schematically showing the droplet ejection head 41 as viewed from below, or the side corresponding to the opposed substrate 15. FIG. 5 is a plan view showing the droplet ejection head 41 as viewed from above. FIGS. 6 and 7 are side views schematically showing the droplet ejection head 41 as viewed in direction Y.

As shown in FIG. 4, a pivotal stage 39a, which has a rectangular parallelepiped shape extending in direction X, is provided below, or above as viewed in the drawing, the carriage 37. The pivotal stage 39a forms a pivot mechanism. A guide stage 39b, which is sized substantially equal to the pivotal stage 39a, is arranged below, or above as viewed in FIG. 4, the pivotal stage 39a.

The pivotal stage 39a is operationally connected to the output shaft of a pivot motor MR (see FIG. 10) housed in the carriage 37. When powered by the pivot motor MR, the pivotal stage 39a pivots the guide stage 39b about an axis (a pivotal axis C) parallel with a normal direction of the opposed substrate 15 (direction Z). A guide surface 39s, which is a concave surface having an arcuate cross section, is formed on the lower surface, or the upper surface as viewed in FIG. 4, of the guide stage 39b, and extends in direction Y. The center of curvature 39C (see FIG. 6) of the guide surface 39s is located at a position immediately below the guide stage 39b and on the upper surface of the opposed electrode 26 mounted on the substrate stage 33.

In response to a signal instructing to pivot the guide stage 39b, which is provided to the pivot motor MR, the pivot motor MR rotates in a forward direction or a reverse direction by a predetermined number of rotations. This pivots the guide stage 39b on an X-Y plane.

In the illustrated embodiment, the position of the guide stage 39b at which the center of curvature 39C (the single-dotted chain line of FIG. 5) extends parallel with direction Y, as indicated by the solid lines of FIG. 5, is defined as the initial position of the guide stage 39b. The position of the guide stage 39b at which the center of curvature 39C (the single-dotted chain line of FIG. 5) extends along a line pivoted counterclockwise at a predetermined angle (the rotational angle θr) with respect to direction Y, as indicated by the double-dotted chain lines of FIG. 5, is defined as the pivoted position of the guide stage 39b.

Referring to FIG. 4, a tilt stage 40 extending in direction Y is provided on the guide stage 39b. The tilt stage 40 forms a tilt mechanism. A slidable surface 40a, which is a convex surface shaped in correspondence with the guide surface 39s, is formed on the surface facing the guide stage 39b (the lower surface as viewed in FIG. 4) of the tilt stage 40. A securing surface 40b, which is a flat surface, is formed on the surface of the tilt stage 40 opposed to the slidable surface 40a (the upper surface of the tilt stage 40 as viewed in FIG. 4).

The tilt stage 40 is operationally connected to the output shaft of a tilt motor MD (see FIG. 10), which is housed in the carriage 37. When the tilt stage 40 is powered by the tilt motor MD, the slidable surface 40a slides (pivots) along the guide surface 39s. Specifically, the tilt stage 40 tilts about a tilt axis that passes through the center of curvature 39C located on the opposed electrode 26 and relatively with the opposed substrate 15, in such a manner that the slidable surface 40a and the guide surface 39s are located on a common plane. The securing surface 40b thus tilts about the tilt axis passing through the center of curvature 39C and relatively with the opposed substrate 15.

In response to a signal instructing tilting of the securing surface 40b, which is provided to the tilt motor MD, the tilt motor MD is driven to rotate in a forward direction or a reverse direction, and the securing surface 40b of the tilt stage 40 is tilted about the center of curvature 39C.

In the illustrated embodiment, the position of the tilt stage 40 at which an ejecting direction A, or a normal direction of the securing surface 40b, extends parallel with a normal direction of the opposed substrate 15, or direction Z, as indicated by the sold lines of FIG. 6, is defined as the initial position of the tilt stage 40. The position of the tilt stage 40 at which the ejecting direction A is inclined clockwise at the inclination angle θd with respect to direction Z, as illustrated by the double-dotted chain lines of FIG. 6, is defined as the tilt position of the tilt stage 40.

With reference to FIG. 4, a droplet ejection head (hereinafter, referred to as an ejection head) 41, which has a rectangular parallelepiped shape extending in direction Y, is secured to the securing surface 40b. A nozzle plate 42 is formed on the lower side (the upper side as viewed in FIG. 4) of the ejection head 41. A nozzle forming surface 42a (an ejection port forming surface) is formed on the side of the nozzle plate 42 facing the opposed substrate 15 (the upper side of the nozzle plate 42 as viewed in the drawing), extending parallel with the securing surface 40b. A plurality of nozzles N, or ejection ports, are formed in the nozzle forming surface 42a and aligned at equal pitches along direction Y. In the ejection head 41 of the illustrated embodiment, the nozzles N are linearly aligned.

As shown in FIG. 6, each of the nozzles N extends through the nozzle plate 42 along a normal direction of the nozzle forming surface 42a (the securing surface 40b), which is the ejecting direction A. The nozzles N are arranged in such a manner that, when the tilt stage 40 is held at the initial position, the nozzles N are located forward from the center of curvature 39C in direction Z (rearward from the center of curvature 39C in the ejecting direction A). In the illustrated embodiment, positions located on the center of curvature 39C and forward from the nozzles N in the ejecting direction A are defined as droplet receiving positions PF.

As the tilt motor MD rotates in a forward direction, the tilt stage 40 moves from the initial position to the tilt position. This pivots all of the nozzles N clockwise about the center of curvature 39C (the corresponding droplet receiving position PF), as illustrated in FIG. 6. As a result, the extending direction of the nozzles N becomes inclined at the tilt angle θd with respect to a normal line of the opposed substrate 15 (direction Z).

This maintains the distance between each nozzle N and the corresponding droplet receiving position PF at a predetermined traveling distance L. That is, regardless of change of the ejecting direction A, the droplets Fb ejected from the nozzles N are received at the droplet receiving positions PF with maintained accuracy.

Referring to FIG. 7, the ejection head 41 has cavities 43 each of which communicates with the corresponding one of the nozzles N and the ink tank 38. The alignment film forming material F is supplied from the ink tank 38 to the corresponding one of the nozzles N through each of the cavities 43. The ejection head 41 has oscillation plates 44, which are provided in correspondence with the cavities 43. Each of the oscillation plates 44 is capable of oscillating in the ejecting direction A and the direction opposed to the ejecting direction A. This increases and decreases the volume of the corresponding cavity 43. Piezoelectric elements PZ are arranged on the oscillation plates 44 in correspondence with the nozzles N. Each of the piezoelectric elements PZ contracts and extends in response to a piezoelectric element drive signal COM (see FIG. 10). This oscillates the corresponding one of the oscillation plates 44 in the ejecting direction A and the opposite direction.

The piezoelectric element drive signal COM of the present embodiment is generated based on waveform data WD (see FIG. 10), which is set in advance through tests or the like in such a manner that meniscus, which is the interface of the alignment film forming material F in each nozzle N, smoothly oscillates and the weight of each of the droplets Fb stably becomes a predetermined value.

The tilt motor MD is driven to move the tilt stage 40 to the predetermined tilt position. Piezoelectric element drive signals COM are then provided to the prescribed ones of the piezoelectric elements PZ. This increases and decreases the volume of each of the cavities 43 corresponding to the piezoelectric elements PZ, oscillating the meniscus in each of the corresponding nozzles N. Respondingly, as illustrated in FIG. 8, a predetermined weight of the alignment film forming material F is ejected from the nozzles N as the droplets Fb in correspondence with the piezoelectric element drive signals COM. Each of the droplets Fb then flies in the direction defined by the corresponding one of the nozzles N, or the ejecting direction A, at a predetermined ejection velocity Vf.

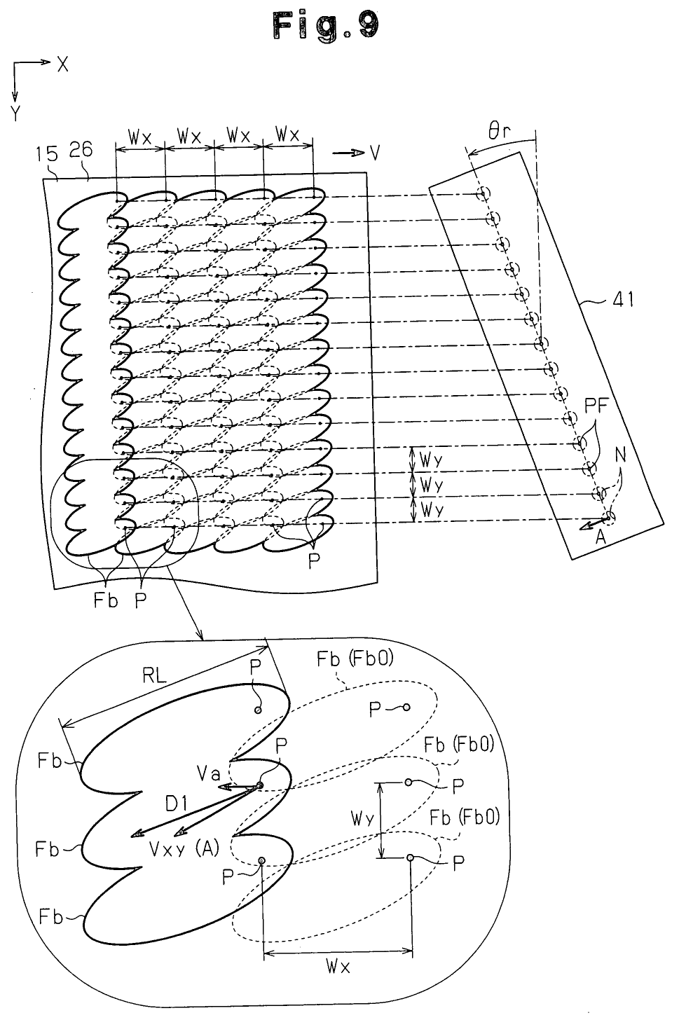

As illustrated in FIG. 9, a plurality of grid points (target positions P) at which the droplets Fb are received by the opposed electrode 26 are set in an area on the opposed electrode 26 in which the alignment film 27 is to be formed.

Specifically, the number of the droplets Fb to be ejected, or the number of the target positions P, is set in correspondence with the target thickness of the alignment film 27 and the weight of each droplet Fb. The interval between each adjacent pair of the target positions P in direction X is defined as the transport ejection pitch Wx. The interval between each adjacent pair of the target positions P in direction Y is defined as the alignment ejection pitch Wy. The transport ejection pitch Wx and the alignment ejection pitch Wy are set in such a manner that the set number of target positions P are contained in the aforementioned area on the opposed electrode 26. Specifically, the alignment ejection pitch Wy is set to a value smaller than the formation pitch between each adjacent pair of the nozzles N.

By controlling actuation of the pivot motor MR in such a manner that the interval between each adjacent pair of the nozzles N as viewed in direction X corresponds to the alignment ejection pitch Wy, the guide stage 39b is pivoted to a predetermined pivot position.

Further, by controlling operation of the tilt motor MD, the tilt stage 40 is tilted to a predetermined tilt position.

Subsequently, the X-axis motor MX is operated to transport the substrate stage 33 in direction X at the transport velocity V. In such transportation, the piezoelectric element drive signals COM are provided to the corresponding piezoelectric elements PZ in correspondence with the timing at which the droplet receiving positions PF reach the corresponding target positions P.

This causes the nozzles N to eject the droplets Fb, and each of the droplets Fb travels in the ejecting direction A, which is determined by the pivot angle θr and the tilt angle θd. The droplets Fb are then successively received at the target positions P (the droplet receiving positions PF).

Specifically, in a direction of the surface of the opposed substrate 15, or along the X-Y plane, a velocity component corresponding to the ejection velocity Vf (hereinafter, referred to as ejection tangential velocity Vxy) is applied to the droplets Fb traveling at the ejection velocity Vf as shown in FIG. 9. Further, the substrate stage 33 is being moved in direction X at the transport velocity V. Therefore, as a velocity component in a direction opposite to direction X and as a velocity component corresponding to the transport velocity V, a velocity component (hereinafater, referred to as transport tangential velocity Va) is applied to each droplet Fb that travels toward the opposed substrate 15 on the substrate stage 33.

This causes each droplet Fb to spread wet on the opposed electrode 26 at a direction D1 and the velocity of a resultant vector obtained by combining the vector of the ejection tangential velocity Vxy and the vector of the transport tangential velocity Va.

Accordingly, after having been received by the opposed electrode 26, each of the droplets Fb forms an oval shape the major axial direction agrees with a direction D1 inclined with respect to direction X, or the transport direction of the opposed substrate 15. Each droplet Fb on the opposed electrode 26 has a length RL corresponding to the major axial direction D1. An end in the major axis direcito D1 between each adjacent pair of the droplets Fb that have been precedently received by the opposed electrode 26 (the preceding droplets Fb0), as viewed in direction Y. For example, in the enlarged view of FIG. 9, when the droplets Fb shown by broken lines are denoted as precedent droplets Fb0, one end of each of the droplets Fb (shown by solid lines), which are subsequently received, is located in a zone between an adjacent pair of the precedent droplets Fb0.

As a result, the gaps between each adjacent pair of the preceding droplets Fb0 in direction Y are reliably filled with the droplets Fb. This improves uniformity of the thickness of the alignment film 27.

The electric configuration of the droplet ejection apparatus 30, which is constructed as above-described, will be explained with reference to FIG. 10.

As illustrated in FIG. 10, a controller 51, which forms a tilt information generating section and a pivot information generating section, includes a CPU, a RAM, and a ROM forming a control section. In accordance with various types of data and programs stored in the RAM or the ROM, the controller 51 transports the substrate stage 33 and moves the carriage 37, while controlling actuation of the piezoelectric elements PZ of the ejection head 41.

An input device 52, an X-axis motor driver circuit 53, a Y-axis motor driver circuit 54, an ejection head driver circuit 55, a tilt mechanism driver circuit 56, and a pivot mechanism driver circuit 57 are connected to the controller 51.

The input device 52 has manipulation switches such as a start switch and a stop switch. The input device 52 outputs different types of manipulation signals to the controller 51, while providing information regarding the target thickness of the alignment film 27 to the controller 51 as a prescribed form of thickness information It.

After receiving the thickness information It from the input device 52, the controller 51 calculates the total weight of the alignment film forming material F that should be ejected onto the opposed electrode 26. Further, in correspondence with the obtained total weight of the alignment film forming material F and the weight of each droplet Fb determined in correspondence with the waveform data WD, the controller 51 calculates the number of the droplets Fb to be ejected, or the transport ejection pitch Wx and the alignment ejection pitch Wy, which regulate the position coordinates of each of the target positions P. In such calculation, the alignment ejection pitch Wy is set to a value smaller than the formation pitch of the nozzles N.

After obtaining the position coordinates of each target position P, the controller 51 generates and stores bit map data BMD, tilt data DD, and pivot data RD, which are necessary for ejection of the droplets Fb.

The bit map data BMD associates each of the target positions P on the opposed electrode 26 with the bit values (0 or 1). In correspondence with each of the bit values, the bit map data BMD indicates whether to turn on or off the corresponding one of the piezoelectric elements PZ. In other words, the bit map data BMD is defined in such a manner that, each time the droplet receiving positions PF reach the corresponding target positions P, the droplets Fb are ejected.

The tilt data DD associates the tilt angle θd with the number of rotations of the tilt motor MD. The pivot data RD associates the pivot angle θr with the number of rotations of the pivot motor MR. Specifically, the pivot data RD is generated in correspondence with the alignment ejection pitch Wy and associates the interval between each adjacent pair of the nozzles N as viewed in direction X, or the interval between each adjacent pair of the nozzles N in direction Y, with the alignment ejection pitch Wy.

The tilt data DD is generated in correspondence with the transport ejection pitch Wx, the alignment ejection pitch Wy, and the pivot data RD. The tilt data DD is provided in such a manner that the major axis RL of each droplet Fb received by the opposed electrode 26 becomes greater than the transport ejection pitch Wx and an end portion of the droplet Fb the major axial-direction is located between the corresponding adjacent pair of the droplets Fb0, which are adjacent to each other in direction Y.

Further, in accordance with the tilt data DD, the minor axis of each droplet Fb on the opposed electrode 26 becomes greater than the alignment ejection pitch Wy.

The X-axis motor driver circuit 53 receives a corresponding drive signal from the controller 51 and, in response to the signal, drives the X-axis motor MX to rotate in a forward or reverse direction. A rotation detector MEX is provided in the X-axis motor MX and sends a detection signal to the X-axis motor driver circuit 53. In correspondence with the detection signal, the X-axis motor driver circuit 53 calculates the movement direction and the movement amount of the substrate stage 33 (the opposed substrate 15) and generates information representing the current position of the substrate stage 33 as substrate position information SPI. The controller 51 receives the substrate position information SPI from the X-axis motor driver circuit 53 and outputs various types of signals.

The Y-axis motor driver circuit 54 receives a corresponding drive signal from the controller 51 and, in response to the signal, drives the Y-axis motor MX to rotate in a forward or reverse direction. A rotation detector MEY is provided in the Y-axis motor MY and provides a detection signal to the Y-axis motor driver circuit 54. In correspondence with the detection signal, the Y-axis motor driver circuit 54 calculates the movement direction and the movement amount of the carriage 37 (the droplet ejection head 41) and generates information representing the current position of the carriage 37 as carriage position information CPI. The controller 51 receives the carriage position information CPI from the Y-axis motor driver circuit 54 and outputs various types of drive signals. [0081] Specifically, before the opposed substrate 15 reaches the position immediately below the carriage 37, the controller 51 generates the bit map data BMD corresponding to a single (forward or reverse) scanning cycle of the opposed substrate 15 based on the substrate position information SPI and the carriage position information CPI. The controller 51 also generates ejection control signals SI synchronized with a prescribed clock signal using the bit map data BMD. Then, in each of the scanning cycles of the opposed substrate 15 by the carriage 37 in movement, the controller 51 serially transfers the ejection control signals SI to the ejection head driver circuit 55.

Further, each time the first droplet receiving positions PF are located at the target positions P, the controller 51 generates ejection timing signals LP, each of which instructs excitement of the corresponding one of the piezoelectric elements PZ, in correspondence with the substrate position information SPI. The controller 51 then sequentially sends the ejection timing signals LP to the ejection head driver circuit 55.

The ejection head 41 is connected to the ejection head driver circuit 55. The controller 51 provides the waveform data WD, the ejection control signals SI, and the ejection timing signals LP to the the ejection head 41. In response to the ejection control signals SI from the controller 51, the ejection head driver circuit 55 sequentially converts the ejection control signals SI from serial forms into parallel forms in correspondence with the piezoelectric elements PZ. Then, each time the controller 51 inputs the ejection timing signal LP to the ejection head driver circuit 55, the ejection head driver circuit 55 provides the piezoelectric element drive signals COM to the selected ones of the piezoelectric elements PZ in correspondence with the ejection control signals SI, which have been converted into the parallel forms. In other words, each time the droplet receiving positions PF reach the target positions P, the ejection head driver circuit 55 provides the piezoelectric element drive signals COM to the corresponding ones of the piezoelectric elements PZ.

In accordance with the tilt data DD provided by the controller 51, the tilt mechanism driver circuit 56 drives the tilt motor MD to rotate in a forward direction or a reverse direction. A tilt motor rotation detector MED is connected to the tilt mechanism driver circuit 56 and sends a detection signal to the tilt mechanism driver circuit 56. Based on the detection signal of the tilt motor rotation detector MED, the tilt mechanism driver circuit 56 calculates the tilt angle θd (the actual tilt angle) of the tilt stage 40. Further, the tilt mechanism driver circuit 56 generates information regarding the obtained actual tilt angle as tilt position information DPI and outputs the information to the controller 51.

In accordance with the pivot data RD provided by the controller 51, the pivot mechanism driver circuit 57 drives the pivot motor MR, which pivots the guide stage 39b, to rotate in a forward direction or a reverse direction. A pivot motor rotation detector MER is connected to the pivot mechanism driver circuit 57 and sends a detection signal to the pivot mechanism driver circuit 57. Based on the detection signal of the pivot motor rotation detector MER, the pivot mechanism driver circuit 57 calculates the pivot angle θr (the actual pivot angle) of the guide stage 39b. Further, the pivot mechanism driver circuit 57 generates information regarding the obtained actual pivot angle as pivot position information RPI and outputs the information to the controller 51.

A method for forming the alignment film 27 using the above-described droplet ejection apparatus 30 will hereafter be described.

First, as illustrated in FIG. 3, the opposed substrate 15 is mounted on the substrate stage 33. At this stage, the substrate stage 33 is located rearward from the carriage 37 in direction X and the carriages 37 is held at the end of the guide member 35 rearmost in direction Y. That is, the guide stage 39b and the tilt stage 40 are maintained at the respective initial positions.

In this state, the input device 52 is manipulated to input the film thickness information It to the controller 51. The controller 51 then stores the bit map data BMD, the tilt data DD, and the pivot data RD, which are generated based on the film thickness information It.

After having produced the tilt data DD, the controller 51 sets the tilt stage 40 at the tilt position based on the tilt data DD through the tilt mechanism driver circuit 56. After having generated the pivot data RD, the controller 51 sets the guide stage 39b at the pivot position based on the pivot data RD through the pivot mechanism driver circuit 57.

After the tilt stage 40 is set at the tilt position, the controller 51 receives the tilt position information DPI from the tilt mechanism driver circuit 56. The controller 51 then determines, in accordance with the tilt position information DPI, whether the actual tilt angle is the tilt angle θd corresponding to the tilt data DD. After the guide stage 39b is set at the pivot position, the controller 51 receives the pivot position information RPI from the pivot mechanism driver circuit 57. The controller 51 then determines, in accordance with the pivot position information RPI, whether the actual pivot angle is the pivot angle θr corresponding to the pivot data RD.

If the controller 51 determines that the actual tilt angle is the tilt angle θd corresponding to the tilt data DD and the actual pivot angle is the pivot angle θr corresponding to the pivot data RD, the controller 51 drives the X-axis motor MX to set the position of the carriage 37 (the positions of the nozzles N) in such a manner that, when the opposed substrate 15 is transported in direction X, each of the droplet receiving positions PF is located at a position on the path of the corresponding one of the target positions P.

Then, the controller 51 drives the X-axis motor MX to start transportation of the substrate stage 33 (the opposed substrate 15) in direction X.

At this stage, the controller 51 outputs the waveform data WD to the ejection head driver circuit 55 synchronously with a prescribed clock signal. Further, the controller 51 generates ejection control signals SI by synchronizing the bit map data BMD corresponding to a single transportation cycle of the substrate stage 33 with a prescribed clock signal. The controller 51 then serially transfers the ejection control signals SI to the ejection head driver circuit 55.

In correspondence with the substrate position information SPI and the carriage position information CPI, the controller 51 provides an ejection timing signal LP to the ejection head driver circuit 55 each time each droplet receiving positions PF reaches the corresponding target position P. Respondingly, the controller 51 executes ejection of droplets in accordance with the ejection control signals SI through the ejection head driver circuit 55. Specifically, each time each droplet receiving positions PF reaches the corresponding target positions P, the controller 51 provides the piezoelectric element drive signals COM corresponding to the waveform data WD to the corresponding ones of the piezoelectric elements PZ. The associated ones of the nozzles N are thus caused to eject the droplets Fb.

The ejection tangential velocity Vxy corresponding to the ejecting direction A and the transport tangential velocity Va corresponding to the transport velocity V of the opposed substrate 15 are applied to each of the droplets Fb ejected from the nozzles N. One end of each droplet Fb received by the opposed electrode 26 along the major axis direction D1 is located between an area between a pair of the precedent droplets Fb0 that are adjacent to each other in direction Y.

As a result, an area between each pair of the droplets Fb that are adjacent to each other in direction Y is filled with another droplet Fb. In this manner, the alignment film 27 with uniform thickness is formed.

The illustrated embodiment has the following advantages.

(1) The ejecting direction A of each droplet Fb is inclined with respect to a normal line of the opposed substrate 15 and the transport direction of the opposed substrate 15 as viewed in a normal direction of the opposed substrate 15.

Therefore, each droplet Fb received by the opposed substrate 15 forms an oval shape having a major axis inclined with respect to the transport direction of the opposed substrate 15. In other words, the major axis RL of each droplet Fb on the opposed substrate 15 is inclined with respect to the direction extending along the target positions P.

As a result, a portion of each droplet Fb that is succeedingly received by the opposed electrode 26 is arranged in the gap between the corresponding pair of the precedently received droplets Fb, which are adjacent to each other in direction Y. Such gap is thus filled with the droplet Fb, improving uniformity of the thickness of the alignment film 27. Thus, a liquid crystal display with improved display quality can be provided.

(2) As viewed in a normal direction of the opposed substrate 15, the substrate stage 33 is transported such that the transport direction of the opposed substrate 15 has a direction component along the ejecting direction A. Thus, the transport tangential velocity Va of the opposed substrate 15 allows each of the droplets Fb to further effectively spread wet on the opposed substrate 15 along the transport direction. This reliably provides the droplets Fb in the gaps between each adjacent pair of the droplets Fb in direction Y.

(3) The nozzle forming surface 42a is pivoted about the pivotal axis C parallel with a normal line of the opposed substrate 15. This inclines the transport direction of the opposed substrate 15 with respect to all of the nozzles N by equal amounts. The major axial directions D1 of all of the droplets Fb received by the opposed substrate 15 thus become the same directions. This suppresses variation of the shapes formed by the droplets Fb on the opposed substrate 15, further enhancing the uniformity of the thickness of the alignment film 27.

(4) The nozzle forming surface 42a is tilted about the tilt axis C parallel with the center of curvature 39C. In this manner, the ejecting directions A of all of the droplets Fb are set as the same directions. The major axes RL of the droplets Fb thus have equal lengths. This suppresses variation of the shapes formed by the droplets Fb on the opposed substrate 15, further improving the uniformity of the thickness of the alignment film 27.

(5) The controller 51 generates the tilt data DD, in accordance with which the nozzle forming surface 42a is tilted, and the pivot data RD, in accordance with which the nozzle forming surface 42a is pivoted. Operation of the guide stage 39b and that of the tilt stage 40 are controlled based on the pivot data RD and the tilt data DD. Therefore, the ejecting direction A of each droplet Fb is adjusted in correspondence with the pivot data RD and the tilt data DD. Further, the major axial direction D1 of each droplet Fb on the opposed substrate 15 is further reliably inclined with respect to the transport direction of the opposed substrate 15.

(6) The pivot data RD and the tilt data DD are produced based on the transport ejection pitch Wx and the alignment ejection pitch Wy of each droplet Fb. The ejecting direction A of each droplet Fb is thus defined in correspondence with the interval between each adjacent pair of the droplets Fb. This allows each droplet Fb to spread wet on the opposed substrate 15 in correspondence with the transport ejection pitch Wx and the alignment ejection pitch Wy. The uniformity of the thickness of the alignment film 27 is thus further reliably enhanced.

The illustrated embodiment may be modified in the following forms.

In the illustrated embodiment, as viewed in the normal direction of the opposed substrate 15, the opposed substrate 15 (the substrate stage 33) moves in the direction opposite to the ejecting direction A. However, the opposed substrate 15 (the substrate stage 33) may be moved in the same direction as the ejecting direction A, as viewed in the normal direction of the opposed substrate 15.

In the illustrated embodiment, the tilt mechanism is embodied by the tilt stage 40. However, the tilt mechanism may be embodied by, for example, the substrate stage 33. That is, the substrate stage 33 may be tilted with respect to the nozzle forming surface 42a.

Although the nozzles N of the illustrated embodiment are aligned along a single line in the ejection head 41, the nozzles N may be aligned along multiple lines.

Instead of moving the substrate stage 33 along direction X, the carriage 37 may be moved along direction X.

In the illustrated embodiment, the pattern is embodied by the alignment film 27 of the liquid crystal display 10. However, for example, different types of thin films, metal wirings, or color filters of the liquid crystal display 10 or other types of electro-optic apparatus may be formed as the pattern. Electro-optic devices other than the liquid crystal display 10 include, for example, displays having a field effect type device (an FED or an SED). The field effect type device emits light from a fluorescent substance by radiating electrons released by an electron release element onto the fluorescent substance. That is, any suitable pattern may be formed according to the present invention as long as the pattern is formed by ejected droplets.

In the illustrated embodiment, the alignment film 24, which is a pattern, is formed on the opposed substrate 15 of the liquid crystal display 10. However, various types of deposts may be formed on other types of plates, such as a silicon substrate, a flexible substrate, and a metal substrate.

Although the electro-optic device is embodied by the liquid crystal display 10, an electroluminescence device, for example, may be formed as the electro-optic device.

1. A method for forming a pattern on a substrate by ejecting droplets containing a pattern forming material from an ejection head onto the substrate, the method comprising:
moving at least one of the ejection head and the substrate relative to the other, wherein the ejection head has a plurality of ejection ports that are aligned along a surface of the substrate;
inclining the direction of alignment of the ejection ports with respect to the direction of the relative movement; and
ejecting droplets containing the pattern forming material from the ejection ports along a direction of ejection that is inclined with respect to a normal line of the substrate while executing the relative movement.

2. The method for forming a pattern on a substrate according to claim 1, further comprising setting the direction of the relative movement in such a manner that the direction of the relative movement has a direction component along the ejection direction as viewed in a normal direction of the substrate.

3. The method for forming a pattern on a substrate according to claim 1, further comprising pivoting the ejection head about a pivotal axis that is parallel with a normal line of the substrate, thereby inclining the alignment direction of the ejection ports with respect to the direction of the relative movement.

4. The method for forming a pattern on a substrate according to claim 1, further comprising tilting the ejection head about a tilt axis that is parallel with a surface of the substrate, thereby setting the ejection direction.

5. A droplet ejection apparatus that ejects droplets containing a pattern forming material onto a substrate, thereby forming a pattern on the substrate, comprising:
an ejection head having a plurality of ejection ports that are aligned along one direction, the droplets being ejected from the ejection ports onto the substrate;
a movement mechanism that moves at least one of the ejection head and the substrate relative to the other;
a tilt mechanism that tilts the ejection head about a tilt axis that is parallel with the alignment direction of the ejection ports, in such a manner that a direction of ejection of the droplets from the ejection ports is inclined with respect to a normal line of the substrate; and
a pivot mechanism that pivots the ejection head about a pivotal axis that is parallel with a normal line of the substrate, in such a manner that the alignment direction of the ejection ports is inclined with respect to the direction of the relative movement.

6. The droplet ejection apparatus according to claim 5, wherein the tilt mechanism tilts the ejection head in such manner that the ejection direction has a direction component along the direction of the relative movement as viewed in a normal direction of the substrate.

7. The droplet ejection apparatus according to claim 5, wherein the movement mechanism includes a substrate stage, and wherein, with the substrate mounted thereon, the substrate stage moves the substrate along the direction of the relative movement.

8. The droplet ejection apparatus according to claim 5, further comprising:
a tilt information generating section that generates tilt information, the tilt information being used for tilting the ejection head in such manner that the ejection direction is inclined with respect to a normal line of the substrate;
a pivot information generating section that generates pivot information, the pivot information being used for pivoting the ejection head in such manner that an alignment direction of the ejection port as viewed in a normal direction of the substrate is inclined with respect to the direction of the relative movement; and
a control section that controls the pivot mechanism and the tilt mechanism based on the pivot information and the tilt information.

9. The droplet ejection apparatus according to claim 8, wherein the pivot information generating section and the tilt information generating section generate the pivot information and the tilt information, respectively, based on an interval between target droplet receiving positions on the substrate.

10. An electro-optic device comprising a substrate on which a pattern has been formed by the droplet ejection apparatus according to claim 5.

11. A method for forming an alignment film on a substrate by ejecting droplets containing an alignment film forming material from an ejection head onto the substrate, the method comprising:
moving at least one of the ejection head and the substrate relative to the other, wherein the ejection head has a plurality of ejection ports that are aligned along a surface of the substrate;
inclining the direction of alignment of the ejection ports with respect to the direction of the relative movement; and
ejecting droplets containing the alignment film forming material from the ejection ports along a direction of ejection that is inclined with respect to a normal line of a substrate while executing the relative movement.

12. An alignment film forming apparatus that forms an alignment film on a substrate by ejecting droplets containing an alignment film forming material onto the substrate, comprising:
an ejection head having a plurality of ejection ports that are aligned along one direction, the droplets being ejected from the ejection ports onto the substrate;
a movement mechanism that moves at least one of the ejection head and the substrate relative to the other;
a tilt mechanism that tilts the ejection head about a tilt axis that is parallel with the alignment direction of the ejection ports, in such a manner that a direction of ejection of the droplets from the ejection ports is inclined with respect to a normal line of the substrate; and
a pivot mechanism that pivots the ejection head about a pivotal axis that is parallel with a normal line of the substrate, in such a manner that the alignment direction of the ejection ports is inclined with respect to the direction of the relative movement.

13. A liquid crystal display comprising a substrate on which an alignment film has been formed by the alignment film forming apparatus according to claim 12.
